(19) United States
(12) Patent Application Publication
(10) Pub. No.: US 2002/0191284 A1
(43) Pub. Date: Dec. 19, 2002

(54) Optical circulator

(76) Inventors: Kok-Wai Chang, Los Altos, CA (US); Jeffrey F. Wheeldon, Ottawa (CA)

Correspondence Address: Hall, Priddy, Myers & Vande Sande, 10220 River Road, Suite 200, Potomac, MD, 20854, US

(21) Appl. No.: 09/879,202

(22) Filed: Jun. 13, 2001

(51) Int. Cl. G02B 5/30

(52) U.S. Cl. 359/484; 359/496; 359/497

(57) ABSTRACT

The invention provides an optical circulator having a plurality of ports, a non-reciprocal rotator, a beam shifter means in the form of at least one birefringent crystal, a polarization rotator, and a reflector. The plurality of ports is sequentially aligned at one end of the device, while the reflector is disposed at an opposite end. First and second lenses provide efficient coupling between the plurality of ports, in combination with the reflector. Conveniently, the beam shifter provides the beam displacement necessary to switch between successive ports, while simultaneously minimizing the size requirements of the other optical components.

### FIELD OF THE INVENTION

This invention relates to optical circulators for use in optical communication systems.

### BACKGROUND OF THE INVENTION

An optical circulator is a passive, non-reciprocal device that directs the propagation of light in one direction among a plurality of input/output optical ports. For example, light launched into a first optical port is circulated to a second optical port, while light launched into the second optical port is circulated to a third optical port. In general, light propagation in a reverse direction from the second optical port back to the first optical port is inhibited.

Several types of optical circulators have been developed. In general, the more successful designs include polarizing beamsplitters, non-reciprocal rotators such as Faraday rotators, and reciprocal rotators such as half waveplates.

For example, one particularly successful design was proposed by Cheng in U.S. Pat. No. 5,991,076, incorporated herein by reference. The device taught by Cheng is a polarization insensitive three port optical circulator having two identical groups of optical elements disposed on either side of a pair of collimating/focussing lenses. Each group includes a polarizing beamsplitter in the form of a first birefringent crystal for separating an input beam of light launched into the first port into two orthogonally polarized sub-beams of light, at least one half waveplate for making the polarization of both sub-beams parallel, a Faraday rotator, and beam shifting means in the form of a second birefringent crystal for passing light launched from the first port to the second port and for directing light launched from the second port to the third port, wherein the first and third ports are on one side of the device and the second port is on an opposite side of the device.

Advantageously, this optical arrangement minimizes the size of costly optical components such as the birefringent crystals and provides optimum coupling between ports. However, this symmetrical design has the disadvantage that it can be time consuming to align, is difficult to manufacture as a more than three port device, and requires a number of costly optical components. For example, the design typically requires two polarizing beamsplitters, two sets of reciprocal rotators, two non-reciprocal rotators and two beam shifting means.

In U.S. Pat. No. 5,930,422, incorporated herein by reference, Cheng discloses a reflective optical circulator that uses about half the optical components disclosed in U.S. Pat. No. 5,991,076. Specifically, the optical circulator uses one polarizing beamsplitter, one Faraday rotator, one beam shifting means, one lens, and one reflector. The single lens is used as a light redirector, rather than a collimating/focussing element. Accordingly, the reflected light is disadvantageously incident on the circulating components with a nonzero angle of incidence. Moreover, the optical circulator disclosed therein requires very precise and time-consuming optical alignment to achieve optimal optical coupling.

It is an object of the instant invention to provide an optical circulator that overcomes the above limitations.

It is a further object of the instant invention to provide a compact optical circulator that has a folded configuration.

### SUMMARY OF THE INVENTION

The instant invention relates to a reflective optical circulator that includes a non-reciprocal rotator, beam shifting means, first and second lenses, a polarization rotator, and a reflector. The input/output ports of the optical circulator are sequentially aligned at one end of the device, while the reflector is disposed at an opposite end. The first and second lenses provide efficient coupling between the input and output ports, in combination with the reflector. More specifically, the first and second lenses provide an imaging system wherein the reflector is in the image plane of the input/output ports such that light transmitted to the reflector is folded directly back along substantially the same optical path. Conveniently, the beam shifting means provides the beam displacement necessary to switch between successive ports, while simultaneously minimizing the size requirements of the other optical components. Notably, the beam displacement is provided in one of the forward and backward propagating directions.

In accordance with the instant invention there is provided an optical circulator having first, second, and third ports for transmitting light from the first port to the second port, and from the second port to a third port, circularly, comprising:

first polarization means for converting light launched from one of the first and second ports into a beam of light having a predetermined polarization;

beam shifting means for receiving the beam of light having the predetermined polarization and for providing one of a beam displacement and substantially no beam displacement in dependence upon a polarization state of the beam of light;

second polarization means for rotating the polarization of the beam of light transmitted from the beam shifting means;

reflecting means for redirecting the beam of light transmitted from the second polarization means back along a substantially same optical path; and

imaging means for optically coupling the first, second, and third ports and the reflecting means, the imaging means having a first focal plane substantially at the first, second, and third ports and a second focal plane substantially at the reflecting means.

For example, in one embodiment the first polarization means includes a polarization diversity unit having at least one birefringent crystal for converting the light launched from one of the input ports into polarized light. In another embodiment, the polarized light is provided with a plurality of polarization maintaining waveguides or a linear polarizer. Advantageously, embodiments including a polarization diversity unit are polarization insensitive.

In accordance with the instant invention there is provided an optical circulator comprising:

a plurality of ports including a first port for launching a first beam of light in a forward propagating direction, a second port for receiving the first beam of light in a backward propagating direction and launching a second beam of light in the forward propagating direction, and a third port for receiving the second beam of light in the backward propagating direction, the first and second ports and the second and third ports each separated by a distance d;

a reflector optically coupled to the plurality of ports for redirecting the first and second beams of light propagating in the forward direction in the backward direction;

a non-reciprocal rotator optically disposed between the plurality of ports and the reflector for rotating the polarization of the first and second beams of light in the forward and backwards propagating directions by a predetermined angle;

a beam shifter optically disposed between the plurality of ports and the reflector for providing a beam displacement substantially equal to d for the first and second beams of light in one of the forward and backward propagating directions in dependence upon a polarization state thereof;

a polarization rotator optically disposed between the beam shifter and the reflector for rotating the polarization of the first and second beams of light between the forward and backward propagating directions; and

imaging means for providing collimating and focussing of the first and second beams of light.

In accordance with the instant invention there is provided an optical circulator comprising:

a plurality of ports disposed at a first end;

a reflector disposed at a second end optically coupled to the plurality of ports;

polarization diversity means optically coupled to the plurality of ports and the reflector for splitting a beam of light launched from a port of the plurality of ports into two forward propagating orthogonally polarized sub-beams of light, and for combining two backward propagating orthogonally polarized sub-beams of light into a single beam of light;

a non-reciprocal rotator optically coupled to the polarization diversity means for rotating the polarization of each forward and backward propagating sub-beam of light transmitted therethrough by a predetermined angle,

beam shifting means optically coupled to the non-reciprocal rotator for providing a beam displacement for each forward and backward propagating sub-beam of light transmitted therethrough in dependence upon the polarization thereof;

a polarization rotator optically coupled to the beam shifting means for rotating the polarization of each forward and backward propagating sub-beam of light such that only one of the forward propagating sub-beams of light and the backward propagating sub-beams of light experiences the beam displacement; and

imaging means optically coupled to the plurality of ports and the reflector, the imaging means having a first focal plane substantially at the plurality of ports and a second focal plane substantially at the reflector.

### BRIEF DESCRIPTION OF THE DRAWINGS

Exemplary embodiments of the invention will now be described in conjunction with the drawings in which:

FIG. 1a is a schematic diagram of an embodiment of an optical circulator in accordance with the instant invention viewed from the side;

FIG. 1b is a top view of the optical circulator shown in FIG. 1a;

FIG. 1c is a schematic diagram showing the operation of the optical circulator shown in FIG. 1a;

FIG. 2a is a schematic diagram of another embodiment of an optical circulator in accordance with the instant invention viewed from the side;

FIG. 2b is a top view of the optical circulator shown in FIG. 2a;

FIG. 2c is a schematic diagram showing the operation of the optical circulator shown in FIG. 2a;

FIG. 3a is a schematic diagram of another embodiment of an optical circulator in accordance with the instant invention viewed from the side;

FIG. 3b is a top view of the optical circulator shown in FIG. 3a;

FIG. 3c is a schematic diagram showing the operation of the optical circulator shown in FIG. 3a;

FIG. 4a is a schematic diagram of another embodiment of an optical circulator in accordance with the instant invention viewed from the side;

FIG. 4b is a top view of the optical circulator shown in FIG. 4a;

FIG. 4c is a schematic diagram showing the operation of the optical circulator shown in FIG. 4a;

FIG. 5a is a schematic diagram of another embodiment of an optical circulator in accordance with the instant invention viewed from the side;

FIG. 5b is a top view of the optical circulator shown in FIG. 5a;

FIG. 5c is a schematic diagram showing the operation of the optical circulator shown in FIG. 5a; and,

FIG. 6a is a schematic diagram of yet another embodiment of an optical circulator in accordance with the instant invention.

### DETAILED DESCRIPTION OF THE INVENTION

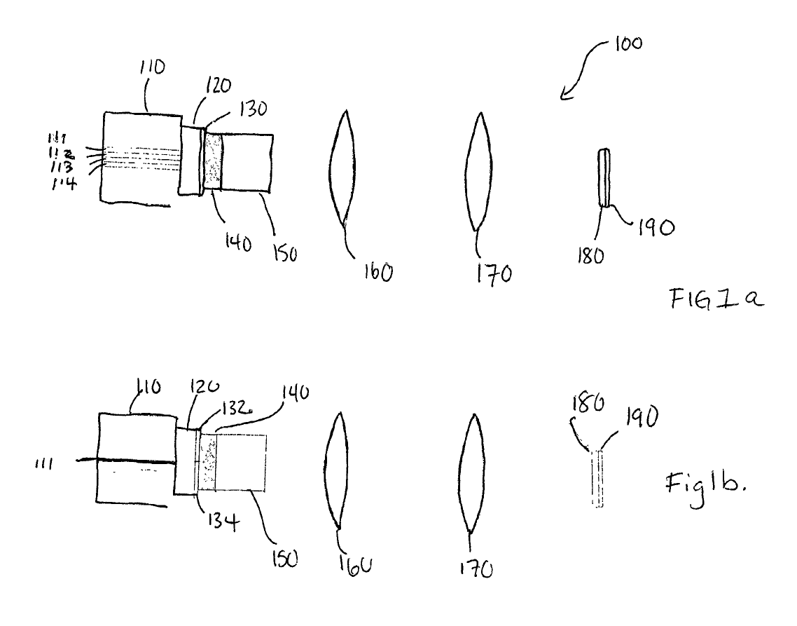

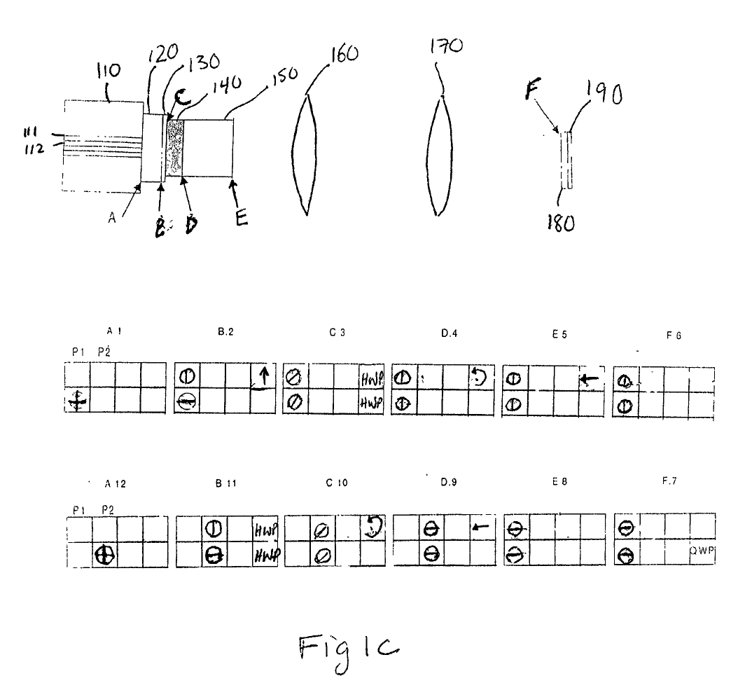

Turning now to FIGS. 1a and 1b there is shown an optical circulator in accordance with an embodiment of the instant invention. The optical circulator 100 includes a tube 110 for housing a plurality of optical waveguides, conveniently shown as first 111, second 112, third 113, and fourth 114 optical fibres. Optionally, each fibre has a thermally expanded core. Each optical fibre 111, 112, 113, 114 is optically coupled to a first polarizing beam splitter in the form of a birefringent crystal 120, which splits a beam of light launched from one of the plurality of fibres 111, 112, 113, 114 into first and second sub-beams of light having orthogonal polarization states. A reciprocal polarization unit 130 is provided to ensure that both sub-beams of light have the same polarization state. For example, in this embodiment the reciprocal polarization unit 130 includes first 132 and second 134 orthogonally oriented half-waveplates for rotating the polarization of each sub-beam by −45° and +45°, respectively. Alternatively, the reciprocal polarization unit 130 includes a spacer (not shown) and a half waveplate (not shown) for rotating the polarization of each sub-beam by 0° and 90°, respectively. The first birefringent crystal 120 is optically coupled to a non-reciprocal polarization rotator 140, such as a Faraday rotator, which rotates the polarization state of both sub-beams of light by about 45°. The non-reciprocal polarization rotator 140 is optically coupled to a second birefringent crystal 150. Conveniently, the walk-off direction (i.e., the offset direction) of the second birefringent crystal 150 is parallel to a straight line coincident with each fibre end of the plurality of fibres 111, 112, 113, 114. The walk-off direction of first birefringent crystal 120 is approximately 90° or −90° to the walk-off direction of the second birefringent crystal 150. The second birefringent crystal 150 provides a beam displacement for each sub-beam of light passing therethrough in dependence upon its polarization state. Preferably, the first 120 and second 150 birefringent crystals are rutile, yttrium vanadate, magnesium fluoride, quartz, lithium niobate, or calcite crystals. An at least partially reflective surface 190, such as a mirror, is provided to redirect light propagating in a forward direction from the plurality of fibres 111, 112, 113, and 114 to light propagating in a backwards direction towards the plurality of fibres 111, 112, 113 and 114, while a polarization rotator 180, such as a quarter waveplate, or a second Faraday rotator, is provided for switching between orthogonal polarization states for the forward and backward propagating light. Conveniently, the reflective surface 190 is optionally coated on the polarization rotator 180. A first lens 160 having a focal plane substantially at the plurality of fibres 111, 112, 113, and 114 and second lens 170 having a focal plane substantially at the mirror 190, are provided for focussing and collimating each sub-beam of light passing therethrough. For example, GRIN, spherical, and aspherical lenses are all suitable for providing the necessary collimating and focussing effects. More specifically, the first 160 and second 170 lenses provide an imaging system wherein the ends of optical fibres 111, 112, 113 and 114 are imaged onto the imaging plane coincident with the mirror 190. Optionally, the first 160 and second 170 lenses provide different magnifications, however, it is preferred that the first 160 and second 170 lenses provide a one-to-one optical arrangement or imaging system.

Referring to FIG. 1c, the operation of the device is described in further detail. A beam of light launched from the first optical fibre 111 is passed through the first birefringent crystal 120, which passes a first sub-beam corresponding to the ordinary component and provides a spatial displacement for a second sub-beam corresponding to the extraordinary component, as indicated in B.2. The sub-beam corresponding to the extraordinary component passes through half waveplate 132 where its polarization is rotated by +45°, while the sub-beam corresponding to the ordinary component passes through half waveplate 134 where its polarization is rotated by −45°, as indicated in C.3. Each sub-beam of light is transmitted through the Faraday rotator 140 where its polarization state is rotated by approximately 45° as shown in D.4. Since the second birefringent crystal 150 is oriented to pass light having the polarization indicated at D.4, each sub-beam passes through the second birefringent crystal 150 and lenses 160 and 170 with substantially no change or displacement. Each sub-beam of light passes through the quarter waveplate 180 where it becomes circularly polarized, and is reflected by mirror 190 such that it passes through the quarter waveplate 180 a second time. The net effect of the double pass is that the polarization states of both sub-beams of light are rotated by 90° as shown in F.7. Each sub-beam of light propagates through the second 170 and first 160 lenses and is incident on the second birefringent crystal 150. Since the polarization state of each sub-beam was rotated by 90° by the quarter waveplate 180, each sub-beam propagates along the extraordinary path of the polarizing beam splitter 150 such that a beam displacement dependent on the length of the crystal 150 is achieved. Conveniently, the length of the second birefringent crystal 150 is selected such that each sub-beam is shifted a distance substantially equal to the distance between the first 111 and second 112 optical fibres, as shown in D.9. For example, a beam displacement of about 125 μm is usually convenient. Each sub-beam propagates through the Faraday rotator 140, the reciprocal polarization unit 130, and finally the first birefringent crystal where they are combined and output the second fibre 112. Similarly, an input optical signal launched from the second optical fibre 112 is coupled into the third optical fibre 113, and an input optical signal launched from the third optical fibre 113 is coupled into the fourth optical fibre 114.

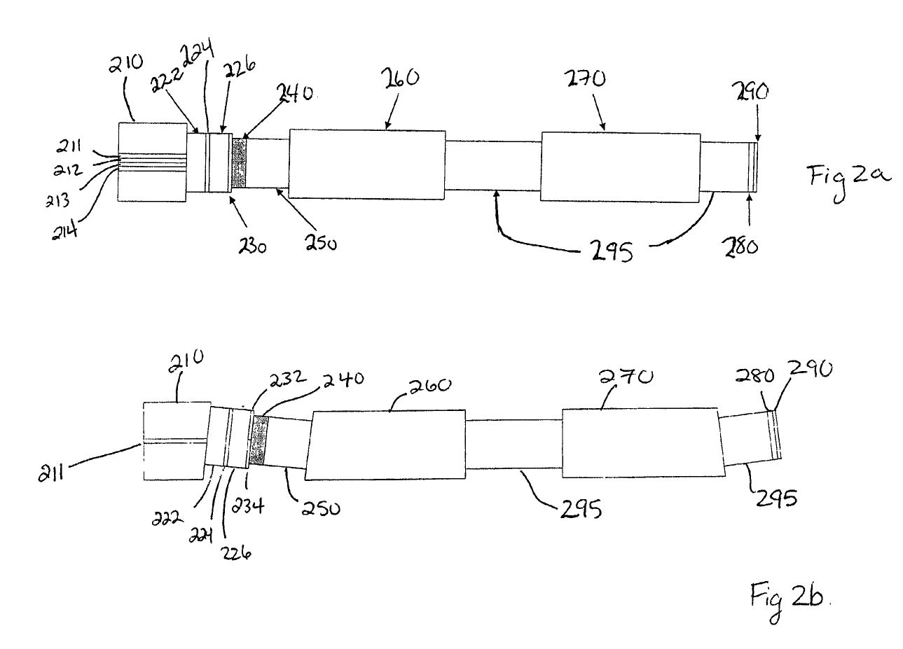

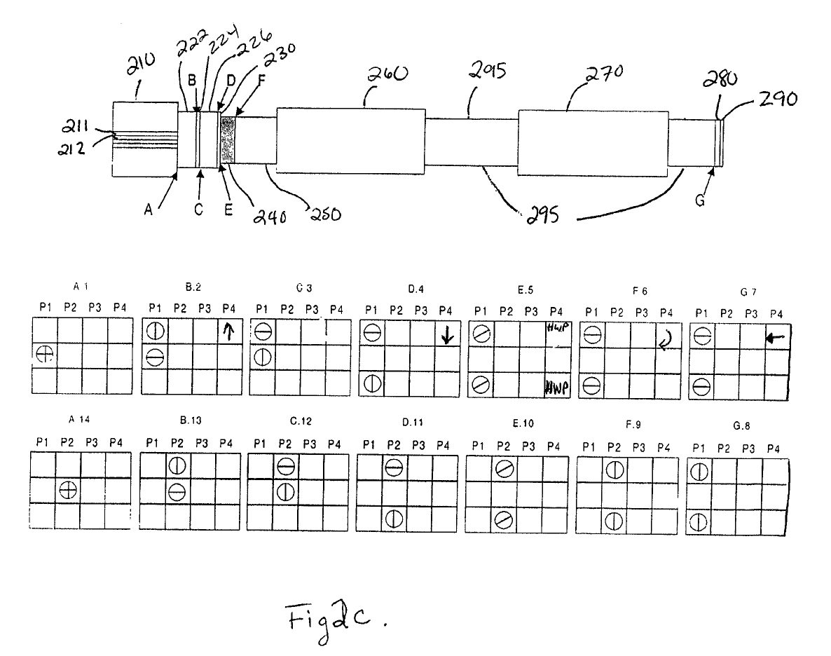

Referring to FIGS. 2a and 2b there is shown an alternate embodiment of an optical circulator in accordance with the instant invention. In this embodiment parts 210, 211, 212, 213, 214, 230, 240, 250, 260, 270, 280, and 290 are similar to parts 110, 111, 112, 113, 114, 130, 140, 150, 160, 170, 180, and 190 discussed above. However, in the instant embodiment a first birefringent plate 222, a reciprocal rotator 224, and a second birefringent plate 226 oppositely oriented from the first birefringent plate 222, provide the two orthogonally polarized sub-beams of light, rather than the birefringent crystal 120 shown in FIGS. 1a and 1b. More specifically, the first 222 and second 226 birefringent plates are oppositely oriented such that their respective walk-off directions are at 180°. Conveniently, the walk-off directions of the first 222 and second 226 birefringent plates are at a 90° angle to the walk-off direction of the second birefringent crystal 250, which is parallel to a straight line coincident with each fibre end of the plurality of fibres 211, 212, 213, 214. Preferably, the reciprocal rotator 224 is a half waveplate for rotating the polarization state of each sub-beam by about 90°. Optionally, tube 210, first GRIN lens 260, and second GRIN lens 270 are provided with slanted end faces to reduce backreflections. Furthermore, optional spacers 295 having a predetermined refractive index are provided to maintain beam alignment. Since the path length between the ordinary and extraordinary components is substantially equalized by this embodiment, polarization mode dispersion (PMD)) is significantly reduced.

Referring to FIG. 2c, the operation of the device is described in further detail. A beam of light launched from the first optical fibre 211 is passed through the birefringent plate 222 where a first sub-beam corresponding to the ordinary component is transmitted straight through and a second sub-beam corresponding to the extraordinary component experiences a spatial walk-off, as indicated in B.2. Each sub-beam subsequently passes through the half waveplate 224 where its polarization state is rotated by 90°, and the second birefringent plate 226 where the first sub-beam experiences an opposite spatial walk-off and the second sub-beam passes straight through, as indicated in C.3 and D.4, respectively. The first sub-beam of light passes through half waveplate 234 where its polarization is rotated by +45°, while the second sub-beam passes through half waveplate 232 where its polarization is rotated by −45°, as indicated in E.5. Each sub-beam of light is transmitted through the Faraday rotator 240 where its polarization state is rotated by approximately 45° as shown in F.6. Since the second birefringent crystal 250 is oriented to pass light having the polarization indicated at F.6, each sub-beam passes through the second birefringent crystal 250 and lenses 260 and 270 with substantially no change. Each sub-beam of light passes through the quarter waveplate 280 where it becomes circularly polarized, and is reflected by mirror 290 such that it passes through the quarter waveplate 280 a second time. The net effect is that the polarization states of each of the first and second sub-beams of light is rotated by 90° as shown in G.8. Each sub-beam of light propagates through the second 270 and first 260 lenses and is incident on the second birefringent crystal 250. Since the polarization state of each sub-beam was rotated by 90° by the quarter waveplate 280, each sub-beam propagates along the extraordinary path of the birefringent crystal 250 such that a beam displacement dependent on the length of the crystal 250 is achieved. Conveniently, the length of the second birefringent crystal 250 is selected such that each sub-beam is shifted a distance substantially equal to the distance between the first 211 and second 212 optical fibres as shown F.9. For example, a beam displacement of about 125 μm is typical. Each sub-beam propagates through the Faraday rotator 240, the reciprocal polarization unit 230, and finally the second birefringent plate 226, the reciprocal rotator 224, and the first birefringent plate 222 where they are combined and output the second fibre 212. Similarly, an input optical signal launched from the second optical fibre 212 is coupled into the third optical fibre 213, and an input optical signal launched from the third optical fibre 213 is coupled into the fourth optical fibre 214.

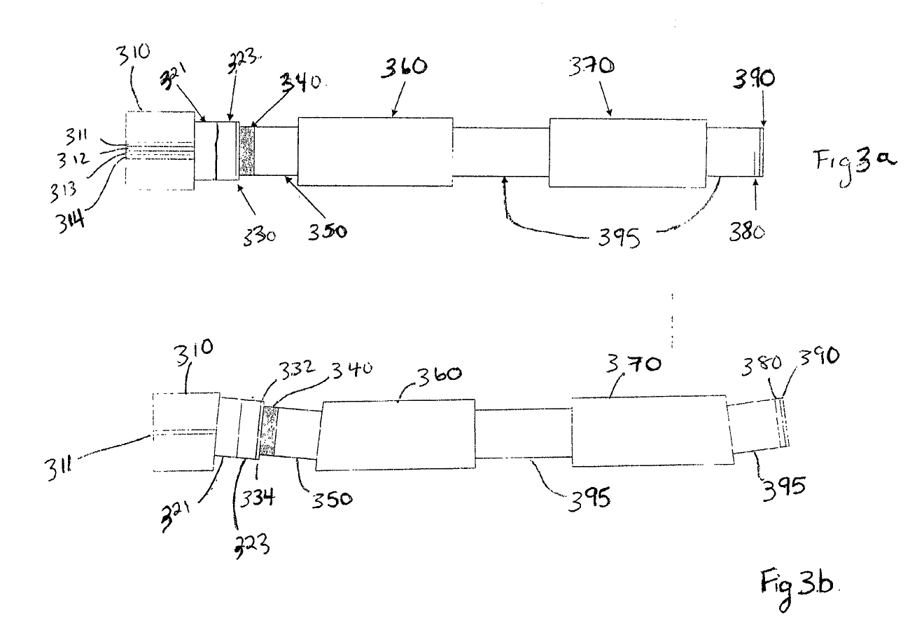

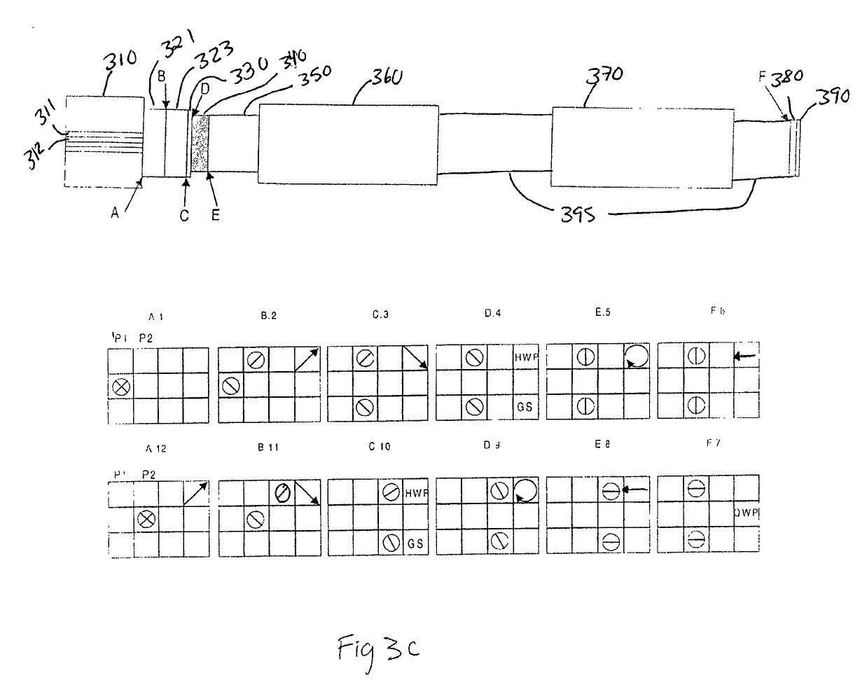

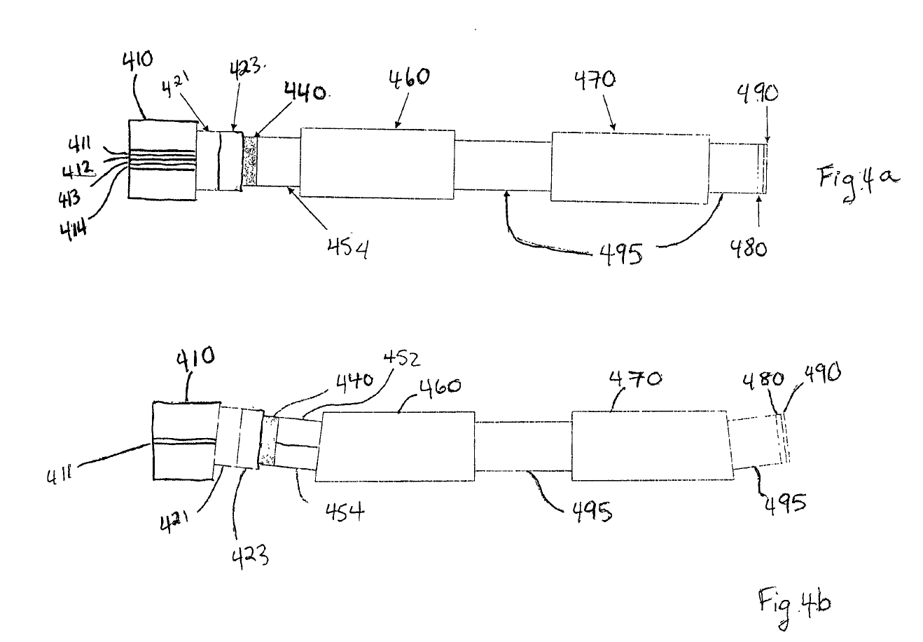

Referring to FIGS. 3a and 3b there is shown another embodiment of the optical circulator. In this embodiment parts 310, 311, 312, 313, 314, 340, 350, 360, 370, 380, and 390 are similar to parts 110, 111, 112, 113, 114, 140, 150, 160, 170, 180, and 190 discussed above with respect to FIGS. 1a and 1b. However, in the instant embodiment a first birefringent plate 321 and a second birefringent plate 323 oriented perpendicularly to the first birefringent plate 321, provide two orthogonally polarized sub-beams of light, rather than the birefringent crystal 120 shown in FIGS. 1a and 1b. More specifically, the first birefringent plate 321 has a walk-off direction that is perpendicular to the walk-off direction of the second birefringent plate 323. The walk-off directions of the first 321 and second 323 birefringent plates are at a 45° angle to the walk-off direction of the second birefringent crystal 350, which is parallel to a straight line coincident with each fibre end of the plurality of fibres 311, 312, 313, 314. In this embodiment, the reciprocal polarization unit 330 includes half waveplate 332 and glass spacer 334. Preferably, the glass spacer 334 has the same refractive index as the half waveplate 332. Optionally, tube 310, first GRIN lens 360, and second GRIN lens 370 are provided with slanted end faces to reduce backreflections. Furthermore, optional spacers 395 are provided. Since the path length between the ordinary and extraordinary components is substantially equalized by this embodiment, polarization mode dispersion (PMD) is advantageously reduced.

Referring to FIG. 3c, the operation of the device is described in further detail. A beam of light launched from the first optical fibre 311 is passed through the birefringent plate 321 where a first sub-beam is walked off in a first direction while a second sub-beam is transmitted straight through, as indicated in B.2. When the first and second sub-beams pass through the second birefringentt plate 323, the first sub-beam is passed straight through while the second sub-beam is walked off in a second direction perpendicular to the first, as indicated in C.3. The first sub-beam of light passes through half waveplate 132 where its polarization is rotated by 90°, while the second sub-beam passes through spacer 134 where its polarization not rotated, as indicated in D.4. Each sub-beam of light is transmitted through the Faraday rotator 340 where its polarization state is rotated by approximately 45° as shown in E.5. Since the second birefringent crystal 350 is oriented to pass light having the polarization indicated at E.5, each sub-beam passes through the second birefringent crystal 350 and lenses 360 and 370 with substantially no change. Each sub-beam of light passes through the quarter waveplate 380 where it becomes circularly polarized, and is reflected by mirror 390 such that it passes through the quarter waveplate 380 a second time. The net effect is that the polarization states of each of the first and second sub-beams of light are rotated by 90° as shown in F.7. Each sub-beam of light propagates through the second 370 and first 360 lenses and is incident on the second birefringent crystal 350. Since the polarization state of each sub-beam was rotated by 90° by the quarter waveplate 380, each sub-beam propagates along the extraordinary path of the birefringent crystal 350 such that a beam displacement dependent on the length of the crystal 350 is achieved. Conveniently, the length of the second birefringent crystal 350 is selected such that each sub-beam is shifted a distance substantially equal to the distance between the first 311 and second 312 optical fibres. Notably, the spatial displacement provided by the first 321 and second 323 birefringent plates, which is preferably the same, does not necessarily correspond to the beam displacement provided by the second birefringent crystal 350. For example, a beam displacement of about 125 μm is typically provided by the second birefringent crystal, while a spatial displacement provided by the first 321 and second 323 birefringent plates could range from 100 to 400 μm. Each sub-beam propagates through the Faraday rotator 340, the reciprocal polarization unit 330, and finally the first 321 and second 323 birefringent plates, where they are combined and output the second fibre 312. Similarly, an input optical signal launched from the second optical fibre 312 is coupled into the third optical fibre 313, and an input optical signal launched from the third optical fibre 313 is coupled into the fourth optical fibre 314.

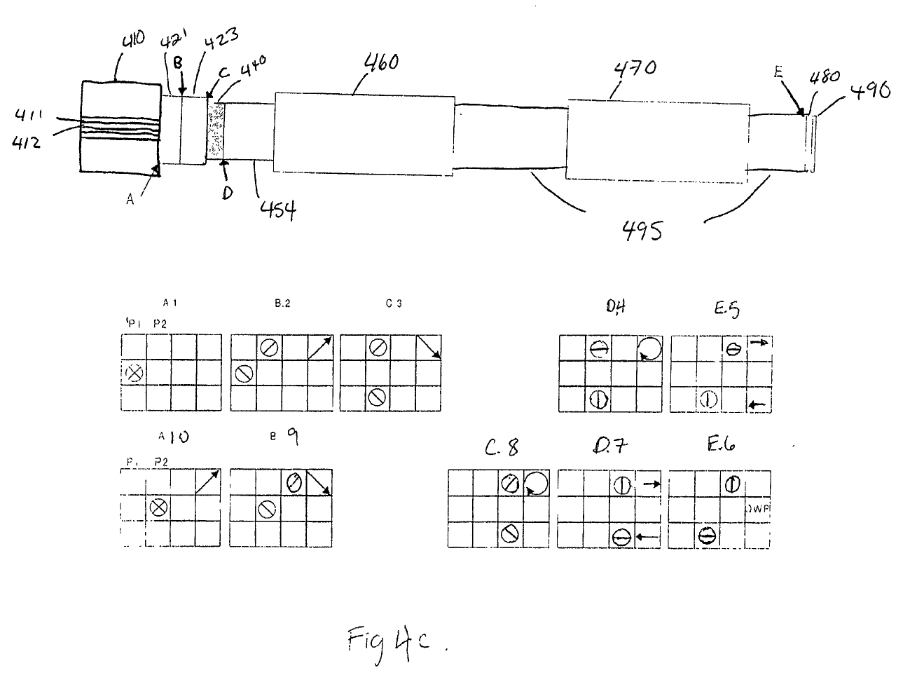

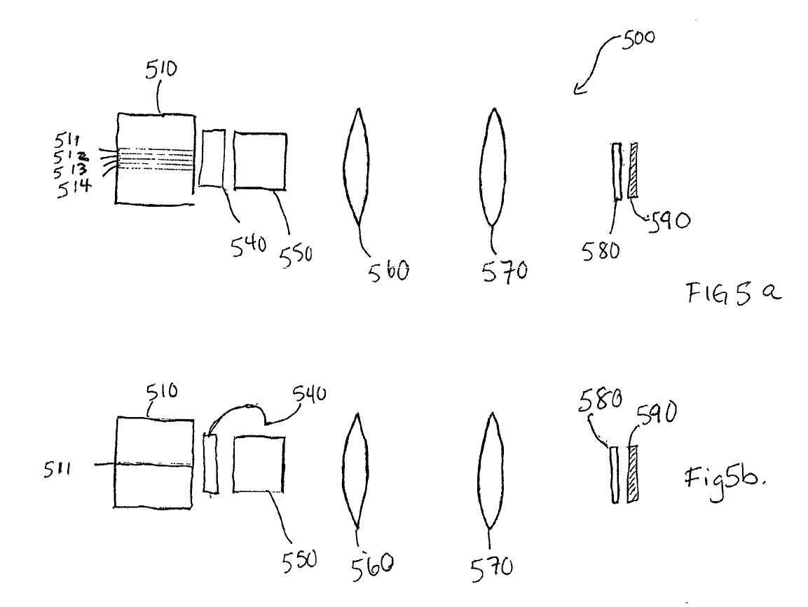

Referring to FIGS. 4a and 4b there is shown yet another embodiment of the optical circulator. In this embodiment parts 410, 411, 412, 413, 414, 440, 460, 470, 480, and 490 are similar to parts 110, 111, 112, 113, 114, 140, 160, 170, 180, and 190 discussed above with respect to FIGS. 1a and 1b. However, in the instant embodiment a first birefringent plate 421 and a second birefringent plate 423 oriented perpendicularly to the first birefringent plate 421, provide two orthogonally polarized sub-beams of light, rather than the birefringent crystal 120 shown in FIGS. 1a and 1b. Similarly, first 452 and second 454 birefringent crystals replace the birefringent crystal 150 shown in FIGS. 1a and 1b. Preferably, the walk-off directions of the first 421 and second 423 birefringent plates are perpendicular to one another, the walk-off directions of the first 452 and second 454 birefringent crystals are opposite one another, and the walk-off directions of the first 421 and second 423 birefringent plates are at a 45° or 135° angle to the walk-off directions of the first 452 second 454 birefringent crystals. Optionally, tube 410, first GRIN lens 460, and second GRIN lens 470 are provided with slanted end faces to reduce backreflections. Furthermore, optional spacers 495 are provided. Since the path length between the ordinary and extraordinary components is substantially equalized by this embodiment, polarization mode dispersion (PMD) is significantly reduced. Advantageously, this embodiment further obviates the need for a reciprocal polarization unit (e.g., 330 shown in FIGS. 3a and 3b).

Referring to FIG. 4c, the operation of the device is described in further detail. A beam of light launched from the first optical fibre 411 is passed through the birefringent plate 421 where a first sub-beam is walked off in a first direction while a second sub-beam is transmitted straight through, as indicated in B.2. When the first and second sub-beams of light pass through the second orthogonally oriented birefringent plate 423, the first sub-beam is passed straight through while the second sub-beam is walked off in a second direction perpendicular to the first, as indicated in C.3. Each sub-beam of light is transmitted through the Faraday rotator 440 where its polarization state is rotated by approximately 45° as shown in D.4. The first sub-beam of light passes through the first birefringent crystal 452 where it is walked off in a third direction, while the second sub-beam of light passes through the second birefringent crystal 454 where it is passed straight through with substantially no walk-off, as shown in E.5. Each sub-beam of light passes through the quarter waveplate 480 where it becomes circularly polarized, and is reflected by mirror 490 such that it passes through the quarter waveplate 480 a second time. The net effect is that the polarization states of each of the first and second sub-beams of light are rotated by 90° as shown in E.6, before they are passed through the second 470 and first 460 lenses. Since the polarization state of each sub-beam was rotated by 90° by the quarter waveplate 480, the first sub-beam passes straight through the first birefringent crystal 452, while the second birefringent crystal 454 provides a walk-off for the second sub-beam in the third direction, as shown in D.7. Each sub-beam propagates through the Faraday rotator 440, the first birefringent plate 421, and the second birefringent plate 423, where they are combined and output the second fibre 412. Similarly, an input optical signal launched from the second optical fibre 412 is coupled into the third optical fibre 413, and an input optical signal launched from the third optical fibre 413 is coupled into the fourth optical fibre 414.

In each of the four embodiments described heretofore, a first birefringent crystal (120) or pair of crystals (222/226, 321/323, or 412/423) provide the necessary polarized light. However, other methods of providing polarized light are also within the scope of the invention. For example, a linear polarizer (not shown) or polarization maintaining fibre both provide light having a predetermined polarization.

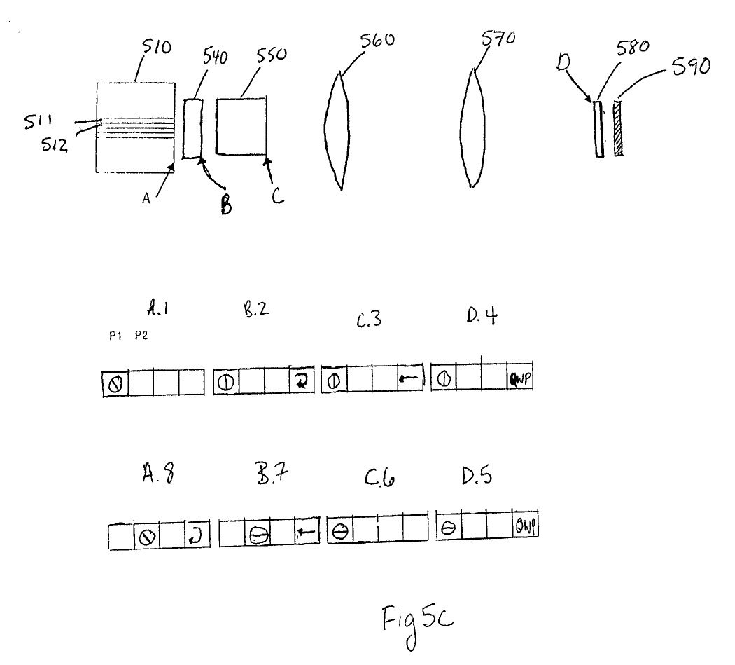

Referring to FIGS. 5a and 5b, there is shown a fifth embodiment of the invention wherein the optical circulator 500 includes a tube 510 for housing a first 511, second 512, third 513, and fourth 514 polarization maintaining (PM) optical fibres. Optionally, each fibre has a thermally expanded core. Each optical fibre 511, 512, 513, 514 is optically coupled to a non-reciprocal polarization rotator 540, such as a Faraday rotator, which rotates the polarization state of a polarized beam of light launched from the first fibre 511 by about 45°. The non-reciprocal polarization rotator 540 is optically coupled to a birefringent crystal 550, which provides a beam displacement for each beam of light passing therethrough in dependence upon its polarization state. An at least partially reflective surface 590, such as a mirror, is provided to convert light propagating in a forward direction from the plurality of fibres 511,512,513, and 514 to light propagating in a backwards direction towards the plurality of fibres 511,112,113 and 514, while a polarization rotator 580, such as a quarter waveplate or a second Faraday rotator, is provided for rotating the polarizations between orthogonal polarization states for the forward and backward propagating light. A first 560 lens having a focal plane substantially at the plurality of fibres 511, 512, 513, and 514 and second 570 lens having a focal plane substantially at the mirror 590, are provided for focussing and collimating each beam of light passing therethrough. For example, GRIN, spherical, and aspherical lenses are all suitable for providing the necessary collimating and focussing effects. More specifically, the first 560 and second 570 lenses provide an imaging system wherein the ends of optical fibres 511, 512, 513 and 514 are imaged onto the imaging plane coincident with the mirror 590. Optionally, the first 560 and second 570 lenses provide different magnifications, however, it is preferred that the first 560 and second 570 lenses provide a one-to-one optical arrangement or imaging system.

Referring to FIG. 5c, the operation of the device is described in further detail. A beam of polarized light launched from the first PM optical fibre 511 is passed through the Faraday rotator 540 where its polarization state is rotated by approximately 45° as shown in B.2. Since the birefringent crystal 550 is oriented to pass light having the polarization indicated at B.2, the beam of light passes through the birefringent crystal 550 with substantially no change or displacement. The beam of light passes through the lenses 560 and 570 and quarter waveplate 580, where it becomes circularly polarized and is reflected by mirror 590 such that it passes through the quarter waveplate 580 a second time. The net effect of the double pass is that the polarization state of the beam of light is rotated by 90° as shown in D.5. The beam of light propagates through the second 570 and first 560 lenses again and is incident on the birefringent crystal 550. Since the polarization state of the beam of light was rotated by 90° by the quarter waveplate 580, it propagates along the extraordinary path of the polarizing beam splitter 550 in the return path, such that it experiences a displacement dependent on the length of the crystal 550. Conveniently, the length and orientation of the birefringent crystal 550 is selected such the backward propagating beam of light aligns with the second fibre 512 as shown in B.7. For example, a beam displacement of about 125 μm is usually convenient. The beam of light subsequently propagates through the Faraday rotator 540 and is output the second PM fibre 512. Similarly, an input optical signal launched from the second PM optical fibre 512 is coupled into the third PM optical fibre 513, and an input optical signal launched from the third PM optical fibre 513 is coupled into the fourth PM optical fibre 514.

Advantageously, the reflective design shown in each of the above embodiments requires only one Faraday rotator and the material for one beam shifting birefringent crystal. This is in contrast to the prior art circulator taught in U.S. Pat. No. 5,991,076, which requires two Faraday rotators and two beam shifting birefringent crystals. This reduction in material represents a reduction in the size of the device and a significant decrease in the over all material cost.

Moreover, the dual lens arrangement provides improved alignment yields since each input beam of light returns to the same plane regardless of its position on the lens. More specifically, the dual lens arrangement provides a retro-reflective system, i.e., the reflected return path is essentially the same as the incident path on the mirror. Accordingly, small movements of the components during the alignment do not cause significant misalignment errors. This is in contrast to prior art circulators taught in U.S. Pat. Nos. 5,991,076 and 5,930,422 that experience lateral displacement errors if the optical components are secured in place with epoxy with even minimal misalignment. Advantageously, an optical circulator in accordance with the instant invention is easily tuned by aligning the reflector during final assembly.

Furthermore, the retro-reflective arrangement provided by the dual lens reduces the size requirements for the optical circulating components. Moreover, the instant invention is easily manufactured as a three, four, or higher port non-reciprocal optical circulator.

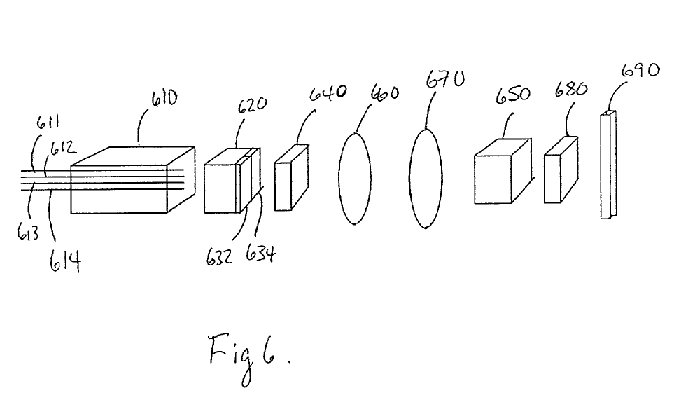

Numerous other embodiments can be envisaged without departing from the spirit and scope of the invention. For example, although the first and second lenses should be optically disposed between the plurality of fibres and the reflector, it is not necessary for them to be arranged as shown in FIGS. 1a, 1b, 1c through to FIGS. 5a, 5b, and 5c. Referring to FIG. 6, there is shown another embodiment of a circulator in accordance with the instant invention, wherein the beam shifting birefringent crystal 650 is disposed between the second lens 670 and the quarter waveplate 680. Notably, this embodiment substantially equalizes the distance between the first lens 660 and the plurality of fibres 611, 612, 613, 614, and the second lens 670 and the reflector 690. Moreover, this embodiment advantageously reduces the distance between the plurality of fibres 611, 612, 613, 614 and the first lens 660. Preferably, each of the polarizing beam splitter 620, the reciprocal polarization unit 630, the non-reciprocal polarization rotator 640, the second birefringent crystal 650, and the polarization rotator 680 are disposed in one of object and image space, and not collimated space. Of course, other arrangements are also possible and within the scope of the invention.

What is claimed is:

1. An optical circulator having first, second, and third ports for transmitting light from the first port to the second port, and from the second port to a third port, circularly, comprising:
first polarization means for converting light launched from one of the first and second ports into a beam of light having a predetermined polarization;
beam shifting means for receiving the beam of light having the predetermined polarization and for providing one of a beam displacement and substantially no beam displacement in dependence upon a polarization state of the beam of light;
second polarization means for rotating the polarization of the beam of light transmitted from the beam shifting means;
reflecting means for redirecting the beam of light transmitted from the second polarization means back along a substantially same optical path; and
imaging means for optically coupling the first, second, and third ports and the reflecting means, the imaging means having a first focal plane substantially at the first, second, and third ports and a second focal plane substantially at the reflecting means.

2. An optical circulator according to claim 1, wherein the first polarization means comprises a non-reciprocal rotator.

3. An optical circulator according to claim 2, wherein the non-reciprocal rotator comprises a Faraday rotator.

4. An optical circulator according to claim 1, wherein the beam shifting beams comprises at least one birefringent crystal.

5. An optical circulator according to claim 1, wherein the second polarization means comprises one of a quarter waveplate and a Faraday rotator.

6. An optical circulator according to claim 4, wherein the at least one birefringent crystal comprises a one of a rutile, a yttrium vanadate, a magnesium fluoride, a quartz, a lithium niobate, and a calcite crystal.

7. An optical circulator according to claim 1, wherein the imaging means comprises a first lens and a second lens in a one-to-one imaging arrangement, each lens comprising one of a GRIN lens, a spherical lens, and an aspherical lens.

8. An optical circulator according to claim 1, wherein the first, second, and third ports comprise ends of thermally expanded core fibre.

9. An optical circulator according to claim 1, wherein the first, second, and third ports comprise ends of polarization maintaining optical fibre.

10. An optical circulator according to claim 1, further comprising at least one spacer having a predetermined refractive index optically coupled to the first, second, and third ports and the reflecting means for maintaining alignment of the beam of light.

11. An optical circulator according to claim 3, wherein the first polarization means further comprises a polarization diversity unit for splitting the light launched from one of the first and second ports into two orthogonally polarized sub-beams of light, and for combining two orthogonally polarized sub-beams of light into a single beam of light.

12. An optical circulator according to claim 11, wherein the polarization diversity unit comprises a first birefringent crystal having a walk-off direction at a predetermined angle to a walk-off direction of the at least one birefringent crystal.

13. An optical circulator according to claim 12, wherein the polarization diversity unit comprises a reciprocal polarization unit for rotating the polarization of at least one of the two orthogonally polarized sub-beams of light such that they have a same polarization state.

14. An optical circulator according to claim 13, wherein the reciprocal polarization unit comprises a spacer and a half waveplate.

15. An optical circulator according to claim 13, wherein the reciprocal polarization unit comprises two oppositely oriented half waveplates.

16. An optical circulator according to claim 12, wherein the polarization diversity unit further comprises a second birefringent crystal for equalizing optical path lengths of the two orthogonally polarized sub-beams of light.

17. An optical circulator according to claim 16, wherein the polarization diversity unit further comprises a reciprocal rotator disposed between the first and second birefringent crystals.

18. An optical circulator according to claim 17, wherein the polarization diversity unit comprises a reciprocal polarization unit for rotating the polarization of at least one of the two orthogonally polarized sub-beams of light such that they have a same polarization state.

19. An optical circulator according to claim 16, wherein the polarization diversity unit comprises a reciprocal polarization unit for rotating the polarization of at least one of the two orthogonally polarized sub-beams of light such that they have a same polarization state.

20. An optical circulator according to claim 16, wherein the beam-shifting means comprises two oppositely oriented birefringent crystals, each of the two birefringent crystals disposed to receive a different sub-beam of light.

21. An optical circulator comprising:
a plurality of ports including a first port for launching a first beam of light in a forward propagating direction, a second port for receiving the first beam of light in a backward propagating direction and launching a second beam of light in the forward propagating direction, and a third port for receiving the second beam of light in the backward propagating direction, the first and second ports and the second and third ports each separated by a distance d;
a reflector optically coupled to the plurality of ports for redirecting the first and second beams of light propagating in the forward direction in the backward direction;
a non-reciprocal rotator optically disposed between the plurality of ports and the reflector for rotating the polarization of the first and second beams of light in the forward and backwards propagating directions by a predetermined angle;
a beam shifter optically disposed between the plurality of ports and the reflector for providing a beam displacement substantially equal to d for the first and second beams of light in one of the forward and backward propagating directions in dependence upon a polarization state thereof;
a polarization rotator optically disposed between the beam shifter and the reflector for rotating the polarization of the first and second beams of light between the forward and backward propagating directions; and
imaging means for providing collimating and focussing of the first and second beams of light.

22. An optical circulator comprising:
a plurality of ports disposed at a first end;
a reflector disposed at a second end optically coupled to the plurality of ports;
polarization diversity means optically coupled to the plurality of ports and the reflector for splitting a beam of light launched from a port of the plurality of ports into two forward propagating orthogonally polarized sub-beams of light, and for combining two backward propagating orthogonally polarized sub-beams of light into a single beam of light;
a non-reciprocal rotator optically coupled to the polarization diversity means for rotating the polarization of each forward and backward propagating sub-beam of light transmitted therethrough by a predetermined angle,
beam shifting means optically coupled to the non-reciprocal rotator for providing a beam displacement for each forward and backward propagating sub-beam of light transmitted therethrough in dependence upon the polarization thereof;
a polarization rotator optically coupled to the beam shifting means for rotating the polarization of each forward and backward propagating sub-beam of light such that only one of the forward propagating sub-beams of light and the backward propagating sub-beams of light experiences the beam displacement; and
imaging means optically coupled to the plurality of ports and the reflector, the imaging means having a first focal plane substantially at the plurality of ports and a second focal plane substantially at the reflector.

23. An optical circulator according to claim 22, comprising reciprocal polarization means disposed between the polarization diversity means and the non-reciprocal rotator for rotating the polarization of at least one of the two forward propagating orthogonally polarized sub-beams of light such it at they have parallel polarization states.

24. An optical circulator according to claim 22, wherein the imaging means comprises a first lens and a second lens, each lens disposed such that a focal plane thereof is substantially at the plurality of ports and the reflector, respectively.
